(19) United States
(12) Patent Application Publication
(10) Pub. No.: US 2018/0157855 A1
(43) Pub. Date: Jun. 7, 2018

(54) IMAGE PROCESSING APPARATUS, METHOD OF NOTIFICATION OF THE NUMBER OF IC CARD PROCESSES FOR THE IMAGE PROCESSING APPARATUS, AND RECORDING MEDIUM

(71) Applicant: Konica Minolta, Inc., Tokyo (JP)

(72) Inventors: Junichi HASE, Osaka (JP); Yuki Asai, Itami-shi (JP)

(73) Assignee: Konica Minolta, Inc., Tokyo (JP)

(21) Appl. No.: 15/830,532

(22) Filed: Dec. 4, 2017

(30) Foreign Application Priority Data
Dec. 7, 2016 (JP) 2016-237713

(51) Int. Cl. G06F 21/60; G06K 7/10; H04L 9/14; H04L 9/30; H04L 9/32; H04N 1/44; H04N 1/00

(52) U.S. Cl. CPC G06F 21/608; G06K 7/10297; G06F 21/602; H04L 9/14; H04N 2201/0094; H04L 9/3226; H04N 1/4433; H04N 1/00411; H04L 9/30

(57) ABSTRACT

An image processing apparatus for a public key cryptography-based system using an IC card comprises: a job execution portion that executes a job given by a user; an IC card reader that accesses the IC card; a first calculator that estimates the number of IC card processes when the job execution portion executes the job, the IC card processes to be performed in the job, the IC card processes requiring the IC card reader to access the IC card; and a notification portion that provides to the user a notification that more than one IC card process is to be performed if the estimation by the first calculator results in more than one IC card process.

The disclosure of Japanese Patent Application No. 2016-237713 filed on Dec. 7, 2016, including description, claims, drawings, and abstract, is incorporated herein by reference in its entirety.

### BACKGROUND

### Technological Field

The present invention relates to an image processing apparatus such as a multi-function peripheral (MFP) i.e. a multifunctional digital image forming apparatus; a method of notification of the number of IC card processes for the image processing apparatus; and a recording medium.

### Description of the Related Art

In a public key cryptography-based system that uses an IC card, an image processing apparatus needs to perform computational processing using a secret key recorded on an IC card before performing a signature process, encrypting, decrypting, and other processing.

Meanwhile, the user may not know which functions cause such computational processing using an IC card or may not know when such computational processing will be started. Some image processing apparatus are known for being configured to instruct the user to prepare the user's IC card when the user failed to do it before a process that requires an IC card.

Specifically, some image processing apparatus, provided with an IC card reader for reading IC cards, are known for being configured to show a document, still image, or video on an operation panel, which instructs the user to touch the IC card reader with the user's IC card or to set the user's IC card in a card housing of the reader.

Japanese Unexamined Patent Application Publication No. 2006-033727 suggests an image forming apparatus that is most preferred to sign a paper document using an IC card. The image forming apparatus creates image data by reading paper-based information and is provided with: a machine signature device that digitally signs image data using a secret key that is unique to the image forming apparatus; a user signature device that digitally signs image data using a secret key that is unique to the user of the image forming apparatus; and a paper unit determining device that determines the unit of paper-based information to be digitally signed by the machine signature device and the user signature device.

Japanese Unexamined Patent Application Publication No. 2008-236067 suggests a digital signature system that facilitates user operation in scanning. The digital signature system includes: a scanner that reads image information on a document; a first user authentication device that conducts user authentication on a user operating the scanner; a scan data memory that stores the image information obtained by the scanner, as being associated with the information of the user authenticated by the first user authentication device; a second user authentication device that conducts user authentication on the user instructing to perform a specific process on the image information stored on the scan data memory; a signature device that signs the image information; a signature check device that judges whether the user authenticated by the first user authentication device is identified as the user authenticated by the second user authentication; and a scan data memory that stores the image information signed by the signature device, as being valid.

However, when the user instructs the image processing apparatus to execute a job using its function, more than one IC card process may be performed in the job and the user's IC card may be required more than once depending on the function.

Since the conventional image processing apparatuses are configured to instruct the user to prepare the user's IC card only once, the user may misunderstand that the user's IC card will be required only once to complete processing. In this case, the user will suffer from an error during the user given job or interruption of the job.

This problem has been unable to be solved by the technology described in Japanese Unexamined Patent Application Publication No. 2006-033727 or Japanese Unexamined Patent Application Publication No. 2008-236067.

### SUMMARY

One object of the present invention is to provide an image processing apparatus to allow the user to know that the user's IC card will be required more than once in the user given job and to improve usability by preventing the user from misunderstanding that the user's IC card will be required only once to complete processing.

Another object of the present invention is to provide a method of notification of the number of IC card processes for the image processing apparatus and a recording medium,

To achieve at least one of the above-mentioned objects, a first aspect of the present invention relates to an image processing apparatus to be employed in a public key cryptography-based system using an IC card, the image processing apparatus comprising:

a job execution portion that executes a job given by a user;

an IC card reader that accesses the IC card;

a first calculator that estimates the number of IC card processes when the job execution portion executes the job, the IC card processes to be performed in the job, the IC card processes requiring the IC card reader to access the IC card; and

a notification portion that provides to the user a notification that more than one IC card process is to be performed if the estimation by the first calculator results in more than one IC card process.

To achieve at least one of the above-mentioned objects, a second aspect of the present invention relates to a method of notification of the number of IC card processes for an image processing apparatus to be employed in a public key cryptography-based system using an IC card, the image processing apparatus comprising:

a job execution portion that executes a job given by a user; and

an IC card reader that accesses the IC card, the program allowing a computer of the image processing apparatus to execute:

estimating the number of IC card processes when the job execution portion executes the job, the IC card processes to be performed in the job, the IC card processes requiring the IC card reader to access the IC card; and

providing to the user a notification that more than one IC card process is to be performed if the estimation results in more than one IC card process.

To achieve at least one of the above-mentioned objects, a third aspect of the present invention relates to a non-transitory computer-readable recording medium storing a program of notification of the number of IC card processes for an image processing apparatus to be employed in a public key cryptography-based system using an IC card, the image processing apparatus comprising:

a job execution portion that executes a job given by a user; and

an IC card reader that accesses the IC card, the program allowing a computer of the image processing apparatus to execute:

estimating the number of IC card processes when the job execution portion executes the job, the IC card processes to be performed in the job, the IC card processes requiring the IC card reader to access the IC card; and

providing to the user a notification that more than one IC card process is to be performed if the estimation results in more than one IC card process.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a block diagram illustrating an electrical configuration of an image processing apparatus according to one embodiment of the present invention;

FIG. 2 illustrates a settings screen for specifying a threshold value on the number of IC card processes and a threshold value on the remaining time to the start or end of the last IC card process;

FIG. 3 illustrates a table showing combinations of conditions and information to be shown on a display depending on the conditions, including the threshold value specified on the number of IC card processes and the threshold value specified on the remaining time;

FIGS. 4A and 4B illustrate a set of screens to be displayed according to the combination 2 in the table of FIG. 3;

FIGS. 5A and 5B illustrate a set of screens to be displayed according to the combination 3 in the table of FIG. 3;

FIG. 6 illustrates a screen to be displayed according to the combination 4 in the table of FIG. 3;

FIG. 7 illustrates a screen to be displayed according to the combination 5 in the table of FIG. 3;

FIGS. 8A, 8B, and 8C illustrate a set of screens to be displayed according to the combination 6 in the table of FIG. 3;

FIG. 9 illustrates a screen to be displayed according to the combination 7 in the table of FIG. 3; and

FIG. 10 is a sequence diagram illustrating a sequence to be run when the image processing apparatus performs a scan job that involves a user signature process.

### DETAILED DESCRIPTION OF EMBODIMENTS

Hereinafter, one or more embodiments of the present invention will be described with reference to the drawings. However, the scope of the invention is not limited to the disclosed embodiments.

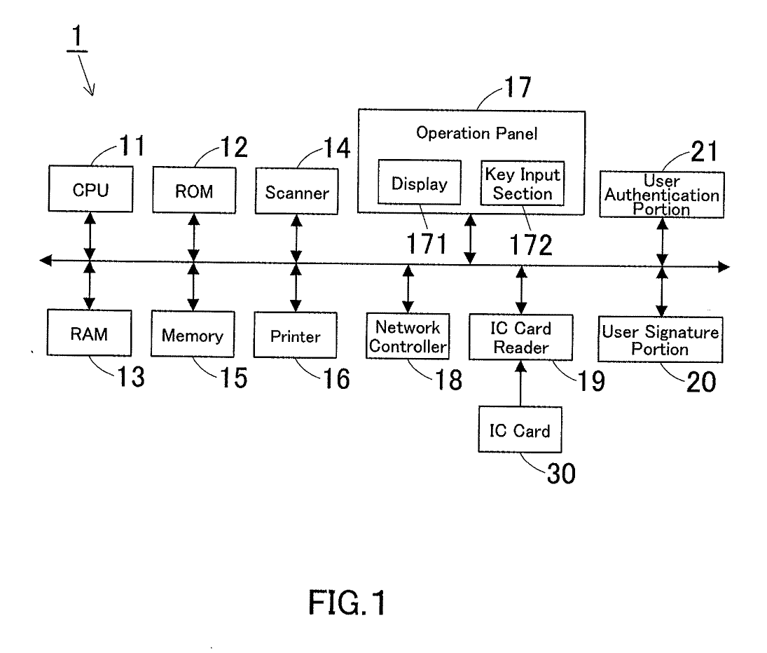

FIG. 1 is a block diagram illustrating an electrical configuration of an image processing apparatus according to one embodiment of the present invention. In this embodiment, an MFP i.e. a multifunctional digital machine having various functions such as copier function, printer function, scanner function, and facsimile function is employed as the image processing apparatus 1. The image processing apparatus 1 is essentially provided with a CPU 11, a ROM 12, a RAM 13, a scanner 14, a memory 15, a printer 16, an operation panel 17, a network controller (NIC) 18, an IC card reader 19, a user signature portion 20, and a user authentication portion 21.

The CPU 11 controls the image processing apparatus 1 in a unified and systematic manner such that the user can use basic functions of the image processing apparatus 1 such as copier function, printer function, scanner function, and facsimile function. When the user gives a job, the CPU 11 estimates the number of times the IC card reader 19 will need to access the user's IC card in the job i.e. the number of IC card processes to be performed in the job. If the estimation results in more than one IC card process, the CPU 11 further makes a display 171 of the operation panel 17 show a notification that more than one IC card process will be performed, and a message and other information about the IC card processes.

The ROM 12 is a memory that stores operation programs for the CPU 11 and other data; the RAM 13 is a memory that provides a work area for the CPU 11 to execute processing in accordance with an operation program.

The scanner 14 is an image reader that digitalizes paper-based information by optically reading an image on a document put on a platen (not shown in this figure), and creates image data in a certain format such as joint photographic experts group (PEG), tag image file format (TIFF), or portable document format (PDF) by conducting image format conversion on the digitalized information; the scanner 14 is configured as a job execution portion accordingly.

The memory 15 is comprised of a non-volatile memory device such as a hard disk drive (HDD). The memory 15 essentially stores image data created by the scanner 14 and digital signatures created by the user signature portion 20.

The printer 16 essentially prints image data created by the scanner 14 and print data received from user terminals in a specified print mode; the printer 16 is configured as a job execution portion accordingly.

The operation panel 17 serves for input for various operations. The operation panel 17 is provided with a display 171 comprised of a touch screen liquid-crystal display that shows messages and operation screens, and a key input section 172 having a numeric keypad, a start key, a stop key, and other keys.

The network controller 18 maintains data transmission and receipt by controlling communications with external apparatuses on the network, such as other image forming apparatuses and user terminals.

The IC card reader 19 is configured to read and write information from and to an IC card 30. Although the IC card reader 19 should not be limited to a certain type, it may be any of the following types: a contact IC card reader with a card slot that is a card housing, designed to access the IC card 30 when it is set in the card slot; a contactless IC card reader designed to access the IC card 30 when it is adjacent; and a dual interface IC card reader having both contact and contactless reading functions. If it is a contactless 1C card reader, the user has to take the trouble to hold the IC card 30 in an area adjacent to the IC card reader 19 (or touch the IC card reader 19 with the IC card 30). The IC card reader 19 may be further provided with an IC card holder that is designed to hold the IC card 30 in an area adjacent to the IC card reader 19, which will disengage the user from taking the trouble.

The IC card 30 is, for example, an IC card issued to a user. The IC card 30 stores a cryptographic key (secret key) (hereinafter to be referred to as “user secret key”) that is unique to the user and a public key certificate (hereinafter to be referred to as “user public key certificate”) that certifies the ownership of the user secret key. The user public key certificate is information essentially including a public key combined with the user secret key, and is issued in advance by a certificate authority.

It is required that the IC card 30 be of a type that matches the type of the IC card reader 19. If the IC card reader 19 is of a contact type, the IC card 30 must be a contact-enabled one; if the IC card reader 19 is of a contactless type, the IC card 30 must be a contactless-enabled one. If the IC card reader 19 is of a dual interface type, the IC card 30 may be any of a contact-enabled one, a contactless-enabled one, or a dual interface support one that can be read by the IC card reader 19 having both contact and contactless reading functions.

The user signature portion 20 has a function of creating a digital signature to image data by encrypting a message digest with a user secret key and a function of decrypting the encrypted data. Hereinafter, digital signatures created by the user signature portion 20 will be referred to as “user signatures”. To be precise, the user signature portion 20 makes the IC card 30, which stores a user secret key, perform computational processing to create a user signature and decrypt the encrypted data. That is because the user secret key must be protected from leaking out of the IC card 30 for a security perspective.

The user authentication portion 21 reads authentication information such as user identification information recorded on the IC card 30, then judges whether or not it is an authenticated user by comparing it to authentication information input by the user.

The user signature portion 20 and the user authentication portion 21 may be configured as functions of the CPU 11.

When the user gives a job that involves an IC card process, the image processing apparatus 1 starts controlling screens on the display 171 of the operation panel 17, which will be described in detail below. Here, an IC card process is a process that uses a secret key recorded on the IC card 30, and it involves a user signature process and decrypting.

The job that involves an IC card process can be any of the following jobs, for example: a scan job that reads a document by the scanner 14, converts it to a PDF file, and performs a PDF signature process that is a process of digitally signing a PDF file; a transmission job that performs a signature transmission process that is a process of transmitting a signature by secure/multipurpose internet mail extensions (S/MIME) that is a common standard related to encapsulated e-mail encryption technology using a public key and encapsulated e-mail digital signature technology; and a print job that decrypts encrypted print data and performs printing.

To log on, the user inputs authentication information to the image processing apparatus 1. The user authentication portion 21 performs user authentication by comparing the authentication information input by the user to the authentication information recorded on the IC card 30. Upon successful completion of user authentication, the user is allowed to log on.

After the user gives a job, the CPU 11 of the image processing apparatus 1 estimates the number of IC card processes to be performed to complete the job, using a secret key recorded on the IC card 30.

The CPU 11 estimates the number of IC card processes to be performed simply using a function to be run by the job. However, when the user gives a scan job that reads a document by the scanner 14, splits the scan data by pages, converts each page of data to a PDF file, and performs a PDF signature process on each PDF file, the scanner 14 need to repeatedly perform reading and a PDF signature process in a parallel manner. In this case, the CPU 11 may alternatively estimate the number of pages, which is equal to the number of IC card processes to be performed, with reference to information of the document loaded on the scanner 14 i.e. the number of sheets of the document.

If the estimation results in more than one IC card process, the CPU 11 notifies the user of the result by making the display 171 show a notification that more than one IC card process will be performed. The notification may be a simple message like “more than one IC card process will be performed” or may be a more practical message like “three IC card processes will be performed” with a specific number. The CPU 11 may show such a notification immediately after estimating the number of IC card processes or when the timing for the first IC card process is on. As described above, it is configured such that a notification that more than one IC card process will be performed is shown on the display 171, and this allows the user to know that the user's IC card will be required more than once. In other words, this allows the user not to misunderstand that the user's IC card will be required only once to complete processing, resulting in improvement of usability.

In this embodiment, it is further configured such that information that is different depending on the various conditions is shown along with a notification that more than one IC card process will be performed.

Specifically, in this embodiment, the CPU 11 estimates the number of IC card processes; but if the estimation results in more than one IC card process, the CPU 11 further estimates the remaining time to the start or end of the last one out of the IC card process. Depending on either or both of the number of IC card processes to be performed and the remaining time, the CPU 11 shows different information (notification).

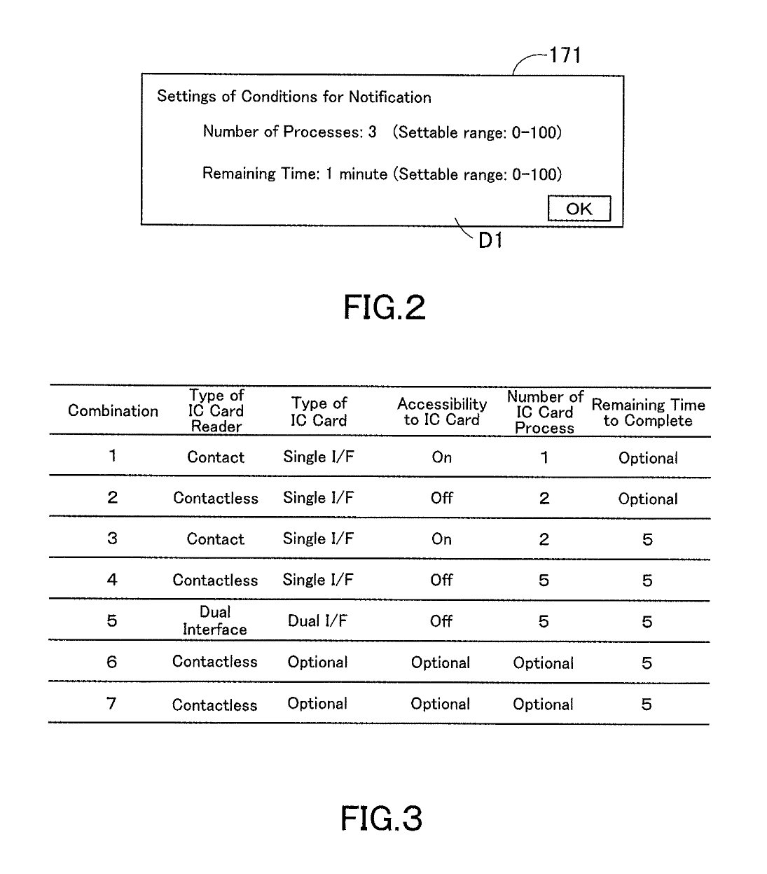

More specifically, an administrative user, for example, is allowed to specify either or both of a threshold value on the number of IC card processes and a threshold value on the remaining time, using the operation panel 17. FIG. 2 illustrates a screen D1 for such a user to specify a threshold value. In this example, an administrative user is allowed to specify both a threshold value on the number of IC card processes and a threshold value on the remaining time. The number of IC card processes can range from 0 to 100; the remaining time can range from 0 to 100 minutes. Specified values are confirmed by the pressing of the “OK” key. In FIG. 2, the threshold value specified on the number of IC card processes is 3, and the threshold value specified on the remaining time is 1.

FIG. 3 illustrates a table showing combinations of conditions and information to be shown on the display 171 depending on the conditions, including the threshold value specified on the number of IC card processes and the threshold value specified on the remaining time. In this table, the “single I/F” in the “type of the IC card” column indicates that the IC card 30 is a contact or contactless-enabled one that matches the type of the IC card reader 19 which is written in the “type of the IC card reader” column. The “dual I/F” in the “type of the IC card” column indicates that the IC card 30 is a dual interface support one.

The “on” in the “accessibility to IC card” column indicates that the IC card 30 is already set in the card housing, for example, of the IC card reader 19 at the start of a job; the “off” in the same column indicates that the IC card 30 is not set in the IC card reader 19 at the start of a job.

Since the threshold value specified on the number of IC card processes is 3, the “5” in the related column is above the specified value; similarly, since the threshold value specified on the remaining time is 1, the “5” in the related column is above the specified value.

According to the combination 1 in the table of FIG. 3, the number of IC card processes is 1. In this case, no notification is shown. Alternatively, a notification that only one IC card process will be performed may be shown.

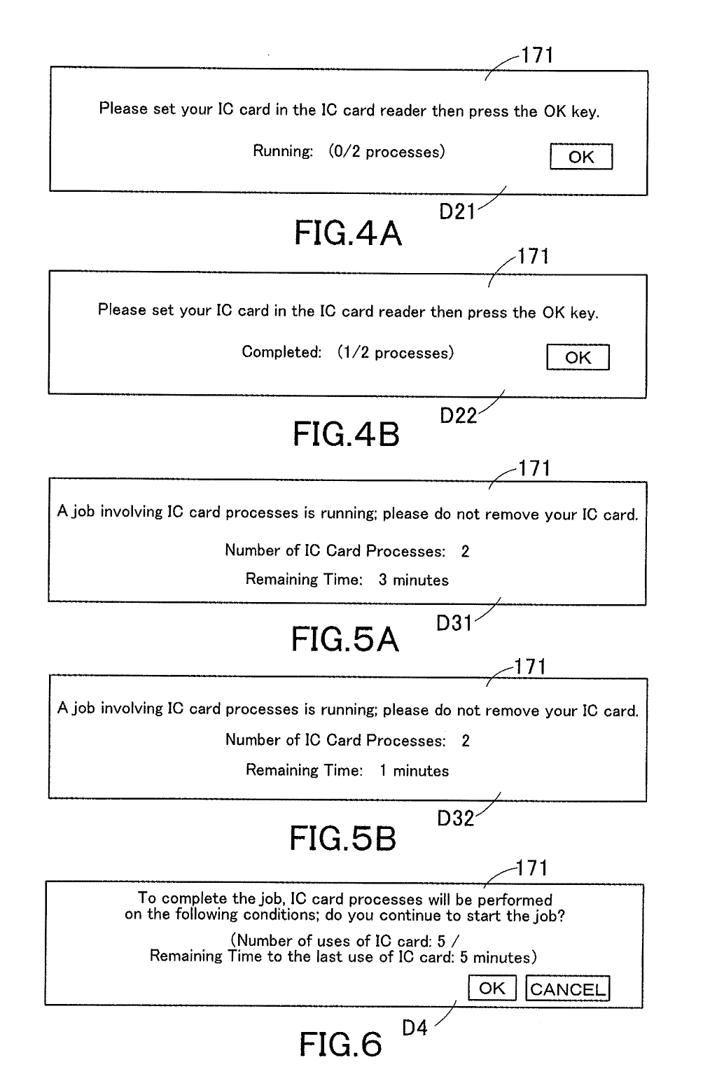

According to the combination 2, the IC card reader 19 is of a contactless type, the IC card 30 is a single I/F one and not set in the IC card reader 19 yet, and the number of IC card processes (2, in this example) is below the threshold value. In this case, a set of screens is displayed as described below. FIGS. 4A and 4B illustrate an example of this set of screens. FIG. 4A illustrates a screen D21 that is a screen to be displayed when the timing for the first IC card process is on. In this screen, a notification that the zeroth one out of the two IC card processes is running (means that no IC card process is running) is shown along with the message “please set your IC card in the IC card reader then press the OK key”. The “OK” key is also shown as well. This screen allows the user to know that the IC card 30 will be required twice.

When the user sets the IC card 30 in the IC card reader 19 then presses the “OK” key, the first IC card process is started. Meanwhile, a notification that the first one out of the two IC card processes is running is shown in a screen on the display 171.

FIG. 4B illustrates a screen D22 that is a screen to be displayed upon completion of the first IC card process. It this screen, a notification that the first one out of the two IC card processes has been completed is shown along with the message “please set your IC card in the IC card reader then press the OK key”. The “OK” key is also shown as well.

When the user sets the IC card 30 in the IC card reader 19 then presses the “OK” key, the second IC card process is started. Meanwhile, a notification that the second one out of the two IC card processes is running is shown in a screen on the display 171.

Upon completion of the job, a notification that the job has been completed is shown in a screen on the display 171.

As described above, it is configured such that, if the IC card reader 19 is of a contactless type and the number of IC card processes is below the threshold value, the number of IC card processes having been completed and a message instructing to use the IC card 30 in a contactiess manner are shown at the time of every IC card process. This allows the user to be sure to hold the IC card 30 in an area adjacent to the IC card reader 19 (or touch the IC card reader 19 with the IC card 30) at the time of every IC card process and to know the number of IC card processes having been completed.

According to the combination 3 in the table of FIG. 3, the IC card reader 19 is of a contact type, the IC card 30 is a single I/F one and already set in the IC card reader 19, the number of IC card processes (2, in this example) is below the threshold value, and the remaining time to the end of the last IC card process (5 minutes, in this example) is the threshold value or above. In this case, a set of screens is displayed as described below.

FIGS. 5A and 5B illustrate an example of this set of screens. In these screens, the remaining time to the end of the last IC card process is shown along with the message “a job involving IC card processes is running; please do not remove your IC card” and the number of IC card processes. FIG. 5A illustrates a screen D31 that is a screen to be displayed when the remaining time is three minutes; FIG. 5B illustrates a screen D32 that is a screen to be displayed when the remaining time is one minute. Before the start of the first IC card process, the remaining time is shown as five minutes. The remaining time is updated on a regular basis, for example, at every minute.

It may be configured such that the number of IC card processes is shown prior to the start of the first one out of the two IC card processes; in this case, it may be further configured such that the remaining time is shown in the screens but, for the sake of simplicity, the number of IC card processes is hidden until completion of the last IC card process.

In the above-described example of FIG. 5, it is configured such that, if the IC card reader 19 is of a contact type, the number of IC card processes is below the threshold value, and the remaining time is the threshold value or above, the remaining time to the end of the last IC card process is shown along with a message warning not to remove the IC card 30 from the IC card reader 19, after the IC card 30 is set in the IC card reader 19. This allows the user to be sure not to remove the IC card 30 from the IC card reader 19 during an IC card process and to know the remaining time to the end of the last IC card process.

According to the combination 4 in the table of FIG. 3, the IC card reader 19 is of a contactless type, the IC card 30 is a single I/F one and not set in the IC card reader 19 yet, the number of IC card processes (5, in this example) is the threshold value or above, and the remaining time to the end of the last IC card process (5 minutes, in this example) is the threshold value or above. In this case, a screen is displayed as described below.

FIG. 6 illustrates a screen D4 as an example of this screen. In the screen D4, the “OK” key and a “CANCEL” key are shown, prior to the first IC card process, along with the message “to complete the job, IC card processes will be performed on the following conditions; do you continue to start the job?”, the number of uses of the IC card 30 (the number of IC card processes), and the remaining time to the end of the last use of the IC card 30 (the remaining time to the end of the last IC card process). The user can start the job by pressing the “OK” key or cancel by pressing the “CANCEL” key. In this example, even if the remaining time to the end of the last IC card process is below the threshold value, the screen D4 of FIG. 6 is displayed at least on the condition that the number of IC card processes is the threshold value or above.

In the above-described example of FIG. 6, it is configured such that, if the number of IC card processes to be performed is the threshold value or above, a message inquiring whether or not to continue to start the job is shown before the job is started. This allows the user to have a choice between to continue to start the job or to cancel the job when the IC card 30 will be required many times.

According to the combination 5 in the table of FIG. 3, the IC card reader 19 is of a dual interface type, the IC card 30 is a dual interface support one and not set in the IC card reader 19 yet, the number of IC card processes (5, in this example) is the threshold value or above, and the remaining time to the end of the last IC card process (5 minutes, in this example) is the threshold value or above. In this case, a screen is displayed as described below.

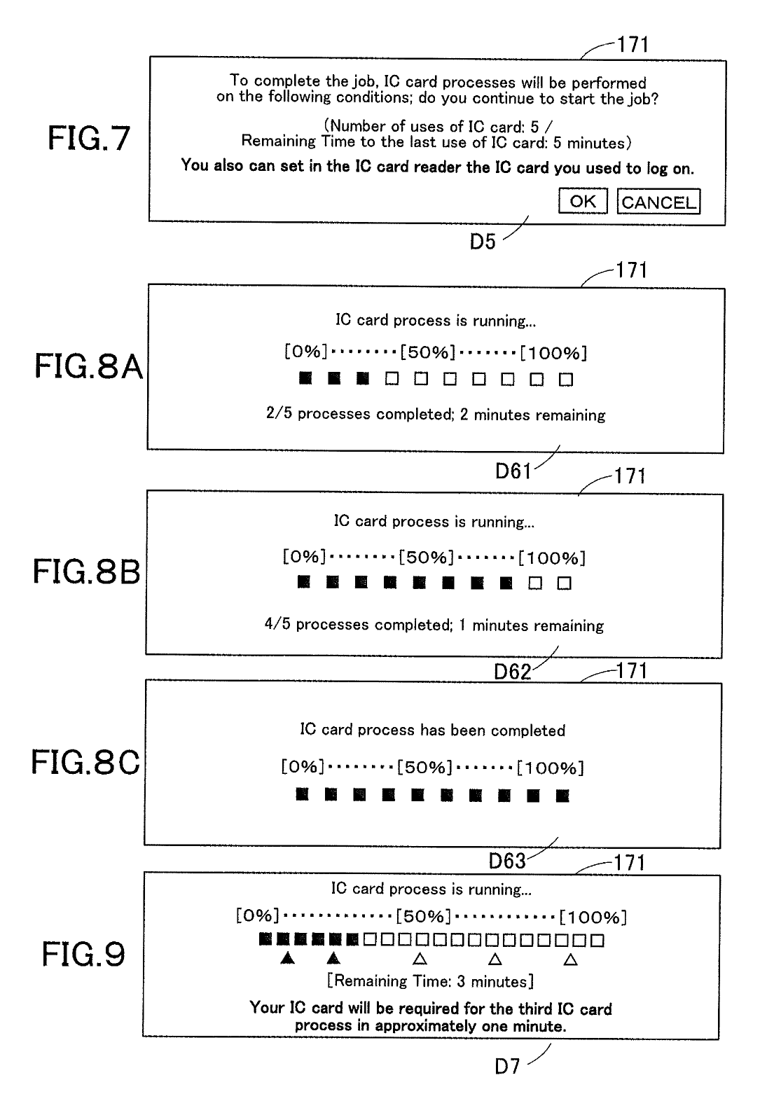

FIG. 7 illustrates a screen D5 as an example of this screen. In the screen D5, the “OK” key and the “CANCEL” key are shown, prior to the first IC card process, along with the message “to complete the job, IC card processes will be performed on the following conditions; do you continue to start the job?”, the number of uses of the IC card 30 (the number of IC card processes), and the remaining time to the end of the last use of the IC card 30 (the remaining time to the end of the last IC card process). Also, the message “you also can set in the IC card reader the IC card you used to log on” is shown as well. Similarly, the user can start the job by pressing the “OK” key or cancel by pressing the “CANCEL” key. In this example, even if the remaining time to the end of the last IC card process is below the threshold value, the screen D5 of FIG. 7 is displayed at least on the condition that the number of IC card processes is the threshold value or above.

In the above-described example of FIG. 7, it is configured such that, if the IC card reader 19 is of a dual interface type, the IC card 30 is a dual interface support one, and the number of IC card processes to be performed is the threshold value or above, a message instructing to use the IC card 30 in a contact manner is shown on the condition that the user logged on using the IC card 30 in a contactless manner. This allows the user to take an alternative action soon and use the IC card 30 in a contact manner. In other words, this allows the user not to bother with using the IC card 30 at the time of every IC card process, resulting in improvement of usability.

After the user sets the IC card 30 in the IC card reader 19 as instructed by the message instructing to use the IC card 30 in a contact manner, the remaining time to the end of the last IC card process may be shown along with the message shown in the screens D31 and D32 of FIG. 5, warning not to remove the IC card 30. This allows the user to easily know the remaining time to the end of the last IC card process.

If the user uses the IC card 30 in a contactiess manner in disregard of the message instructing to use the IC card 30 in a contact manner, the number of IC card processes having been completed may be shown at the time of every IC card process along with the message shown in the screens D21 and D22 of FIG. 4, instructing to set the IC card 30 in the IC card reader 19. Notification of the number of IC card processes having been completed and other information allows the user to easily know the number of times remaining that the IC card 30 will be required.

According to the combination 6 in the table of FIG. 3, the remaining time to the end of the last IC card process (5 minutes, in this example) is the threshold value or above. In this case, a set of screens is displayed as described below.

FIGS. 8A, 8B, and 8C illustrate screens D61, D62, and D63, respectively, as an example of this set of screens. In these screens, the message “IC card process is running”, the text strings “0%”, “50%”, and “100%” indicating the degree of progress, and a progress indicator indicating the progress of the job by boxes are shown along with the number of IC card processes to be performed, the number of IC card processes having been completed, and the remaining time to the end of the last IC card process. The boxes are shown under the text strings indicating the degree of progress. As for the progress indicator indicating the progress of the job, filled boxes represent a completed percent of the job.

The screen D61 of FIG. 8A is a screen to be displayed when the second one out of the five IC card processes has been completed and the remaining time is two minutes; the screen D62 of FIG. 8B is a screen to be displayed when the forth one out of the five IC card processes has been completed and the remaining time is one minute. The screen D63 of FIG. 8C is a screen to be displayed when the last one out of the five IC card processes has been completed. In this screen, the message “IC card process has been completed” and a progress indicator indicating a 100-percent progress of the job by filled boxes only are shown. The number of IC card processes or the remaining time is not shown.

In the above-described example of FIG. 8, it is configured such that, if the remaining time to the end of the last IC card process is the threshold value or above, the number of IC card processes having been completed and the remaining time to the end of the last IC card process are shown. This allows the user to easily know the number of times remaining that the IC card 30 will be required and the remaining time to the end of the last IC card process.

According to the combination 7 in the table of FIG. 3, the remaining time to the end of the last IC card process (5 minutes, in this example) is the threshold value or above. In this case, a different screen from any of the screens D61, D62, and D63 of FIG. 8 is displayed as described below.

FIG. 7 illustrates a screen D7 as an example of this screen. In the screen D7, triangles each representing the timing for an 1C card process are shown along with the message “IC card process is running”, the text strings “0%”, “50%”, and “100%” indicating the degree of progress, a progress indicator indicating the progress of the job by boxes, and the remaining time to the end of the last IC card process. The triangles are shown under the boxes indicating the progress of the job. The number of these triangles is equal to the number of IC card processes to be performed. The filled triangles represent the IC card processes having been completed. Also, a message with the remaining time to the next IC card process is shown as well. In this example, the screen shows a notification that the second IC card process has been completed and the IC card 30 will be required for the third IC card process in approximately one minute.

In the above-described example of FIG. 9, it is configured such that, if the remaining time is the threshold value or above, the timings for IC card processes and the remaining time to the end of the last IC card process are shown. This allows the user to easily know the timings for IC card processes and the remaining time to the end of the last IC card process.

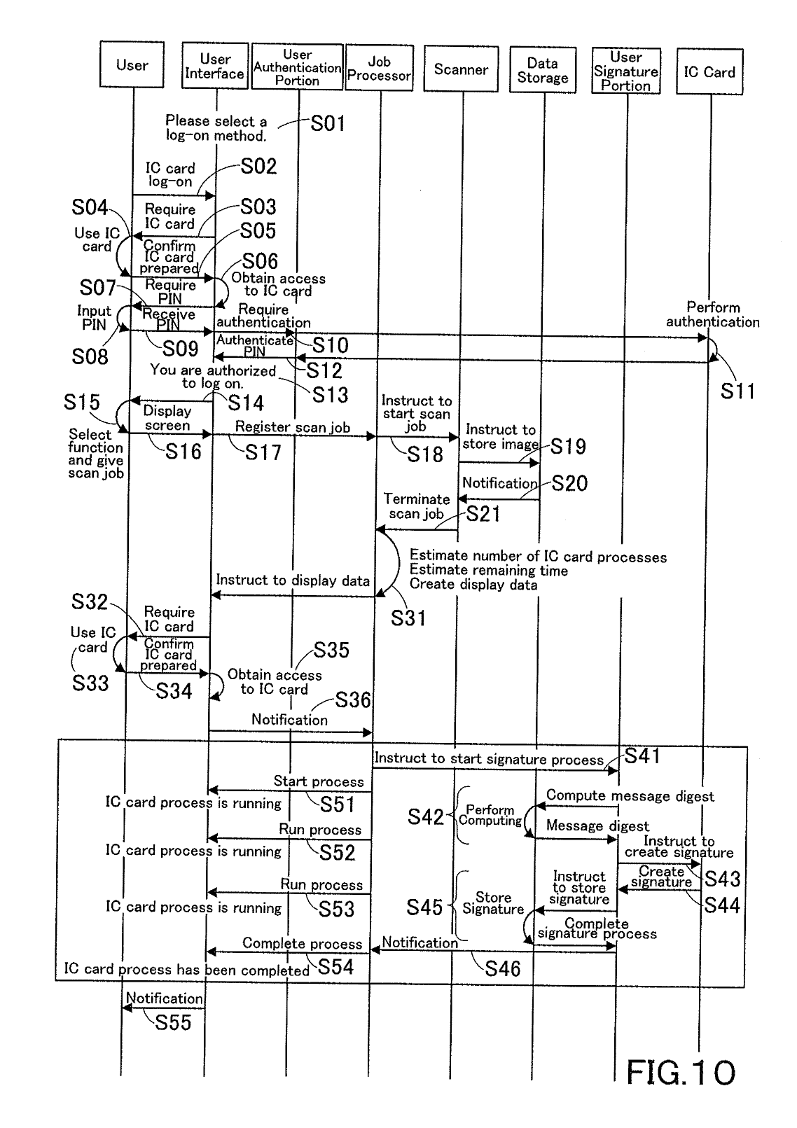

FIG. 10 is a sequence diagram illustrating a sequence to be run when the image processing apparatus 1 performs a scan job that involves a user signature process. The display 171 and the IC card reader 19 are included in the “user interface” in this figure.

For the user intending to log on, the message “please select a log-on method” is shown on the display 171 (Step S01). The user selects IC card log-on (Step S02); a screen with a message requiring the user's IC card is then displayed on the display 171 (Step S03). The user uses the IC card 30 (Step S04) and confirms that the IC card 30 is already prepared (Step S05). The IC card reader 19 obtains access to the IC card 30 (Step S06); a message requiring a personal identification number (PIN) code is then shown on the display 171 (Step S07).

The user inputs a PIN code (Step S08); it is then received (Step S09). The user authentication portion 21 is instructed to perform user authentication (Step S10). The user authentication portion 21 performs user authentication using information recorded on the IC card 30 (Step S11). The user authentication portion 21 successfully completes the authentication (Step S12); a notification that the user is authorized to log on is then shown on the display 171 (Step S13).

An operation screen is displayed on the display 171 (Step S14); via the operation screen, the user selects a function, configures job settings, and gives an instruction to execute a scan job (Step S15). The scan job is received (Step S16) and registered by the job processor (CPU 11) (Step S17). Upon receiving an instruction to start the scan job, the scanner 14 starts reading a document (Step S18). Upon receiving an instruction to store the image data obtained thereby, a data storage such as the RAM 13 or the memory 15 stores the image data (Step S19). The job processor receives a notification of completion of storage from the data storage (Step S20) and terminates the scan job (Step S21).

Subsequently, the number of IC card processes to be performed and the remaining time to the end of the last IC card process are estimated and display data is created as a display screen based on the conditions (Step S31). The display 171 receives an instruction to display the screen using the display data.

The display 171 displays the screen along with a message requiring the IC card 30 (Step S32). The user uses the IC card 30 (Step S33) and confirms that the IC card 30 is already prepared (Step S34). The IC card reader 19 obtains access to the IC card 30 (Step S35) and transmits to the job processor (CPU 11) a notification that the IC card 30 is already prepared (Step S36).

The job processor instructs the user signature portion 20 to start a user signature process (Step S41); and the user signature portion 20 then computes a message digest using the data storage (Step S42). The job processor instructs the IC card 30 to create a user signature (Step S43); and the IC card 30 then creates a user signature (Step S44). The user signature portion 20 stores the created user signature on the data storage to complete a user signature process (Step S45).

After that, the user signature portion 20 transmits a notification of completion of a user signature process (Step S46). The job processor then transmits a notification of completion of an IC card process to the display 171 (Step S54). The display 171 notifies the user of completion of an IC card process (Step S55).

During the time from Step S41, in which the job processor instructs the user signature portion 20 to start a user signature process, until a notification of completion of the first IC card process, a different set of screen is displayed depending on the conditions; for example, a notification that an IC card process is running and the remaining time to the end of the IC card process are shown (Steps S51 to S53).

After that, the boxed steps in FIG. 10, from the instruction to start a user signature process (Step S41) to the notification to the user (Step S55) are performed again for the second IC card process. In the above-described manner, the steps in a box are repeated to complete all the IC card processes.

While one embodiment of the present invention has been described in details herein it should be understood that the present invention is not limited to the foregoing embodiment.

For example, in this embodiment, a notification that more than one IC card process will be performed is shown on the display 171. Alternatively, such a notification may be transmitted to an external apparatus such as the user's own portable terminal apparatus and shown on a display of it. In this embodiment, such a notification is provided by a display screen in a visual manner; alternatively, it may be provided in an auditory manner, for example, by a speaker.

Although embodiments of the present invention have been described and illustrated in detail, it is clearly understood that the same is by way of illustration and example only and not limitation, the scope of the present invention should be interpreted by terms of the appended claims.

What is claimed is:

1. An image processing apparatus to be employed in a public key cryptography-based system using an 1C card, the image processing apparatus comprising:
a job execution portion that executes a job given by a user;
an IC card reader that accesses the IC card;
a first calculator that estimates the number of IC card processes when the job execution portion executes the job, the IC card processes to be performed in the job, the IC card processes requiring the IC card reader to access the IC card; and
a notification portion that provides to the user a notification that more than one IC card process is to be performed if the estimation by the first calculator results in more than one IC card process.

2. The image processing apparatus according to claim 1, further comprising a second calculator that estimates the remaining time to the start or end of the last one out of the IC card process, wherein the notification portion provides different information depending on either or both of the number of the IC card processes estimated by the first calculator and the remaining time estimated by the second calculator.

3. The image processing apparatus according to claim 1, wherein the IC card reader is any of the following types:
a contact IC card reader that accesses the IC card, the IC card being set in a card housing;
a contactless IC card reader that accesses the IC card, the IC card being in an area adjacent to the contactless IC card reader; and
a dual interface IC card reader having both contact and contactless reading functions.

4. The image processing apparatus according to claim 1, further comprising a threshold specification portion that specifies either or both of a threshold value on the number of the IC card processes and a threshold value on the remaining time, wherein the notification portion provides different information depending on whether or not the number of the IC card processes or the remaining time is above the threshold value specified by the threshold specification portion.

5. The image processing apparatus according to claim 1, wherein the notification portion provides different information depending on the type of IC card reader.

6. The image processing apparatus according to claim 5, wherein, if the IC card reader is of a contactless type and the number of the IC card processes is below the threshold value, the notification portion provides a message instructing to hold the IC card in an area adjacent to the IC card reader and the number of IC card processes having been completed, at the time of every IC card process.

7. The image processing apparatus according to claim 5, wherein, if the IC card reader is of a contact type, the number of the IC card processes is below the threshold value, and the remaining time is the threshold value or above, the notification portion provides a message warning not to remove the IC card from the IC card reader and the remaining time to the end of the last IC card process, after the IC card is set in the IC card reader.

8. The image processing apparatus according to claim 4, wherein, if the number of the IC card processes to be performed is the threshold value or above, the notification portion provides a message inquiring whether or not to continue to start the job, before the job is started.

9. The image processing apparatus according to claim 3, wherein, if the IC card reader is of a dual interface type, the IC card 30 is a dual interface support one matching the 1C card reader having both contact and contactless reading functions, and the number of the IC card processes to be performed is the threshold value or above, the notification portion provides a message instructing to use the IC card in a contact manner on the condition that the user has been logged on using the IC card in a contactless manner.

10. The image processing apparatus according to claim 9, wherein, after the user uses the IC card in a contact manner, the notification portion provides the remaining time to the end of the last IC card process.

11. The image processing apparatus according to claim 9, wherein, if the user uses the IC card in a contactless manner in disregard of the message instructing to use the IC card in a contact manner, the notification portion provides the number of IC card processes having been completed.

12. The image processing apparatus according to claim 4, wherein, if the remaining time to the end of the last IC card process is the threshold value or above, the notification portion provides the number of IC card processes having been completed and the remaining time.

13. The image processing apparatus according to claim 4, wherein, if the remaining time to the end of the last IC card process is the threshold value or above, the notification portion provides the timings for the IC card processes and the remaining time.

14. The image processing apparatus according to claim 1, wherein, the job involving the IC card processes is any of the following jobs:
a scan job that reads a document by a scanner, converts it to a PDF file, and performs a PDF signature process;
a transmission job that performs a S/MIME signature transmission process; and
a print job that decrypts encrypted print data and performs printing.

15. The image processing apparatus according to claim 14, wherein:
the scan job reads a document by the scanner, splits scan data by pages, converts each page of data to a PDF file, and performs a PDF signature process on each PDF file; and
if the scanner repeatedly performs reading and a PDF signature process in a parallel manner, the first calculator estimates the number of IC card processes to be performed with reference to information of the document loaded on the scanner.

16. The image processing apparatus according to claim 1, wherein the notification portion is a display of the image processing apparatus, the display showing on a screen a notification that more than one IC card process is to be performed.

17. A method of notification of the number of IC card processes for an image processing apparatus to be employed in a public key cryptography-based system using an IC card, the image processing apparatus comprising:
a job execution portion that executes a job given by a user; and
an IC card reader that accesses the IC card, the program allowing a computer of the image processing apparatus to execute:
estimating the number of IC card processes when the job execution portion executes the job, the IC card processes to be performed in the job, the IC card processes requiring the IC card reader to access the IC card; and
providing to the user a notification that more than one IC card process is to be performed if the estimation results in more than one IC card process.

18. A non-transitory computer-readable recording medium storing a program of notification of the number of IC card processes for an image processing apparatus to be employed in a public key cryptography-based system using an IC card, the image processing apparatus comprising:
a job execution portion that executes a job given by a user; and
an IC card reader that accesses the IC card, the program allowing a computer of the image processing apparatus to execute:
estimating the number of IC card processes when the job execution portion executes the job, the IC card processes to be performed in the job, the IC card processes requiring the IC card reader to access the IC card; and
providing to the user a notification that more than one IC card process is to be performed if the estimation results in more than one IC card process.
